(19) United States
(12) Patent Application Publication
(10) Pub. No.: US 2026/0361014 A1
(43) Pub. Date: Nov. 12, 2026

(54) A RETRACTABLE CONNECTOR ARRANGEMENT

(71) Applicant: ASPIRE ISE AG, Zürich (CH)

(72) Inventors: Bill Passmore, Zürich (CH); Ian Stuart Simms, Zürich (CH); John Harverson, Zürich (CH); Luke Andrew Brown, Zürich (CH)

(73) Assignee: ASPIRE ISE AG, Zürich (CH)

(21) Appl. No.: 19/490,788

(22) PCT Filed: Jun. 7, 2024
(86) PCT No.: PCT/IB2024/055585

§ 371 Date: Dec. 5, 2025

(30) Foreign Application Priority Data
Jun. 9, 2023 (GB) 2308624.2

(51) Int. Cl. H01R 13/00; H01R 25/00; H02G 3/04; H02G 3/18

(52) U.S. Cl. CPC H01R 13/005; H01R 25/006; H02G 3/0493; H02G 3/185; H01R 2201/12

(57) ABSTRACT

A retractable connector arrangement which is installable in a floor of a room. The arrangement includes a base member which defines a recess/cavity, a connector member which is displaceably mounted to the base member, and an actuator. The connector member includes a first set of connectors and a second set of connectors. The second set is vertically spaced from, and located operatively lower than, the first set. The actuator displaces the connector member between at least three different positions. In a retracted position, the connector member is housed in the recess/cavity. In a first extended position, the connector member extends partially out of the recess/cavity such that the first set can be used. In a second extended position both the first and second sets of connectors can be used. A controller operates the actuator and can lock/secure the connector member in each position.

### BACKGROUND OF THE INVENTION

THIS invention relates to a retractable connector arrangement and an operating room system.

In operating rooms, the presence of cables and medical pipes/hoses extending across the floor and from the ceiling (in order to provide connections to various different medical devices/system) can pose a safely risk, as medical personnel may trip over them, catch themselves and equipment on cabling, wires, hoses & tubing. This also makes the surgical space cluttered and more exposed to error, accident and cross contamination as trailing wires, hoses, tubes and cabling are rarely cleaned. Further, the introduction of pendants hanging from the ceiling causes “line of sight issues” as surgeons and clinicians cannot have clear views of medical information screens on the walls of the OR (operating room) displaying images and information critical to the surgical procedure's efficiency and safety. Due to this the clutter factor, efficiency factor and the infection control cross contamination factors are even further compounded due to the additional introduction of screens and equipment into the surgical field, in an effort to bring the visual information closer to the surgeon thus making matters even more difficult.

The Inventors wish to address this problem.

### SUMMARY OF THE INVENTION

In accordance with a first aspect of the invention there is provided a retractable connector arrangement which is installable in a floor of a room, wherein the retractable connector arrangement includes:
a base member which defines a recess/cavity and which is, in use, mounted within the floor;
a connector member which is displaceably mounted to the base member, wherein the connector member includes a first set of one or more connectors and a second set of one or more connectors, wherein the second set of one or more connectors are vertically spaced from, and located operatively lower than, the first set of one or more connectors;
an actuator which is configured to displace the connector member between at least three different positions, wherein the at least three different positions include:
   a retracted position in which the connector member is housed in the recess/cavity,
   a first extended position in which the connector member extends partially out of the recess/cavity such that the first set of one or more connectors is located above the floor so that it is accessible for allowing one or more external connectors to be connected to the first set of one or more connectors, when in use, while the second set of one or more connectors are located below the floor and not accessible for one or more external connectors to be connected thereto, and
   a second extended position in which the connector member extends further out of the recess/cavity than in the first extended position, wherein when the connector member is in its second extended position, the first set of one or more connectors and the second set of one or more connectors are located above the floor so that they are accessible for allowing one or more external connectors to be connected to the first set of one or more connectors and one or more external connectors to be connected to the second set of one or more connectors, when in use; and
a controller for operating the actuator, wherein the controller is configured to lock/secure the connector member in each of its at least three different positions.

The term “floor” used in the specification should be interpreted to also include a ceiling space of a floor level directly below the room (i.e. which is located directly below a floor surface of the room). For example, if the room is located on the second floor, then the “floor” of the room also includes a ceiling space of the first floor level located directly below the room.

The retractable connector arrangement may include one or more UVC (Ultraviolet-C) lights which is/are mounted on the connector member and which is/are configured to perform a decontamination/disinfection function in order to decontaminate/disinfect at least a portion of the room, when in use.

The retractable connector arrangement may include a first circumferential seal which is mounted around the connector member and which is located in-between the first set of one or more connectors and the second set of one or more connectors, whereby when the connector member is in its first extended position, the seal braces/urges against an inner surface of the housing in order to provide a seal.

The first set of one or more connectors may include:
a) a gas connector which is configured to allow a gas pipe/gas hose to be connected thereto;
b) a vacuum connector which is configured to allow a medical vacuum pipe/hose to be connected thereto;
c) a power connector/connection which is configured to allow a power supply cable to be connected thereto; and/or
d) a data connector/connection which is configured to allow a data cable to be connected thereto.

The first set of one or more connectors may therefore include any of the following combinations of the integers (a) to (d) listed above: (a, b); (a, c); (a, d); (b, c); (b, d); (c, d); (a, b, c); (a, b, d); (a, c, d); (b, c, d); or (a, b, c, d).

The first set of one or more connectors may include:
i. at least one oxygen connections/connectors for allowing an oxygen pipe/hose to be connected thereto;
ii. at least one dinitrogenoxide (N2O) connection/connector for allowing a dinitrogenoxide pipe/hose to be connected thereto;
iii. at least one medical air (MA) (e.g. 4 bar) connection/connector for allowing a medical air pipe to be connected thereto (e.g. for supplying medical air to a patient);
iv. at least one surgical air connection/connector for allowing a surgical air pipe (e.g. 7 bar) to be connected thereto in order to provide pressurized air for pressure air driven tools/instruments (e.g. used by surgeons);
v. at least one vacuum tube connection/connector for allowing a vacuum tube to be connected thereto; and/or
vi. at least one AGS (Anaesthetic Gas Scavenging) connection/connector for allowing an AGS pipe to be connected thereto.

The first set of one or more connectors may therefore include any of the following combinations of the integers (i) to (vi) listed above: (i, ii); (i, iii); (i, iv); (i, v); (i, vi); (ii, iii); (ii, iv); (ii, v); (ii, vi); (iii, iv); (iii, v); (iii, vi); (iv, v); (iv, vi); (v, vi); (i, ii, iii); (i, ii, iv); (i, ii, v); (i, ii, vi); (i, iii, iv); (i, iii, v); (i, iii, vi); (i, iv, v); (i, iv, vi); (i, v, vi); (ii, iii, iv); (ii, iii, v); (ii, iii, vi); (ii, iv, v); (ii, iv, vi); (ii, v, vi); (iii, iv, v); (iii, iv, vi); (iii, v, vi); (iv, v, vi); (i, ii, iii, iv); (i, ii, iii, v); (i, ii, iii, vi); (i, ii, iv, v); (i, ii, iv, vi); (i, ii, v, vi); (i, iii, iv, v); (i, iii, iv, vi); (i, iii, v, vi); (i, iv, v, vi); (ii, iii, iv, v); (ii, iii, iv, vi); (ii, iii, v, vi); (ii, iv, v, vi); (iii, iv, v, vi); (i, ii, iii, iv, v); (i, ii, iii, iv, vi); (i, ii, iii, v, vi); (i, ii, iv, v, vi); (i, iii, iv, v, vi); or (ii, iii, iv, v, vi)

The second set of one or more connectors may include:
a) a gas connector which is configured to allow a gas pipe/gas hose to be connected thereto;
b) a vacuum connector which is configured to allow a medical vacuum pipe/hose to be connected thereto;
c) a power connector/connection which is configured to allow a power supply cable to be connected thereto; and/or
d) a data connector/connection which is configured to allow a data cable to be connected thereto.

The second set of one or more connectors may therefore include any of the following combinations of the integers (a) to (d) listed above: (a, b); (a, c); (a, d); (b, c); (b, d); (c, d); (a, b, c); (a, b, d); (a, c, d); (b, c, d); or (a, b, c, d).

The second set of one or more connectors may include:
i. at least one oxygen connections/connectors for allowing an oxygen pipe/hose to be connected thereto;
ii. at least one dinitrogenoxide (N2O) connection/connector for allowing a dinitrogenoxide pipe/hose to be connected thereto;
iii. at least one medical air (MA) (e.g. 4 bar) connection/connector for allowing a medical air pipe to be connected thereto (e.g. for supplying medical air to a patient);
iv. at least one surgical air connection/connector for allowing a surgical air pipe (e.g. 7 bar) to be connected thereto in order to provide pressurized air for pressure air driven tools/instruments (e.g. used by surgeons);
v. at least one vacuum tube connection/connector for allowing a vacuum tube to be connected thereto; and/or
vi. at least one AGS (Anaesthetic Gas Scavenging) connection/connector for allowing an AGS pipe to be connected thereto.

The second set of one or more connectors may therefore include any of the following combinations of the integers (i) to (vi) listed above: (i, ii); (i, iii); (i, iv); (i, v); (i, vi); (ii, iii); (ii, iv); (ii, v); (ii, vi); (iii, iv); (iii, v); (iii, vi); (iv, v); (iv, vi); (v, vi); (i, ii, iii); (i, ii, iv); (i, ii, v); (i, ii, vi); (i, iii, iv); (i, iii, v); (i, iii, vi); (i, iv, v); (i, iv, vi); (i, v, vi); (ii, iii, iv); (ii, iii, v); (ii, iii, vi); (ii, iv, v); (ii, iv, vi); (ii, v, vi); (iii, iv, v); (iii, iv, vi); (iii, v, vi); (iv, v, vi); (i, ii, iii, iv); (i, ii, iii, v); (i, ii, iii, vi); (i, ii, iv, v); (i, ii, iv, vi); (i, ii, v, vi); (i, iii, iv, v); (i, iii, iv, vi); (i, iii, v, vi); (i, iv, v, vi); (ii, iii, iv, V); (ii, iii, iv, vi); (ii, iii, v, vi); (ii, iv, v, vi); (iii, iv, v, vi); (i, ii, iii, iv, v); (i, ii, iii, iv, vi); (i, ii, iii, v, vi); (i, ii, iv, v, vi); (i, iii, iv, v, vi); or (ii, iii, iv, v, vi).

The retractable connector arrangement may include a connector input arrangement which includes
a first gas connector to which a first gas pipe/gas hose can be connected for supplying gas to the retractable connector arrangement, when in use,
a first vacuum connector to which a first vacuum pipe/hose can be connected in order to connect the retractable connector arrangement to a medical vacuum system, when in use;
a first power connector/connection to which a first power supply cable can be connected, when in use, and/or
a first data connector/connection for allowing a first data cable to be connected thereto, when in use,
   wherein the first set of one or more connections includes:
a second gas connector which is fluidly connected to the first gas connector, wherein the second gas connector is configured to allow a second gas pipe/gas hose to be connected thereto such that gas may, in use, flow from the first gas pipe/gas hose to the second gas pipe/gas hose via the first gas connector and the second gas connector;
a second vacuum connector which is fluidly connected to the first vacuum connector, wherein the second vacuum connector is configured to allow a second vacuum pipe/hose to be connected thereto to facilitate flow from the second vacuum pipe/hose to the first vacuum pipe/hose via the second vacuum connector and the first vacuum connector, when in use;
a second power connector/connection which is electrically connected to the first power connector/connection, wherein the second power connector/connection is configured to allow a second power supply cable to be connected thereto in order to allow, in use, power to be supplied from the first power supply cable to the second power supply cable via the first power connector/connection and the second power connector/connection; and/or
a second data connector/connection which is communicatively connected to the first data connector/connection, wherein the second data connector/connection is configured to allow a second data cable to be connected thereto in order to allow for data flow between the first data cable and the second data cable via the first data connector/connection and the second data connector/connection.

When the connector member is in its first extended position, a top portion thereof may protrude less than 150 mm from the floor, when in use. More specifically, when the connector member is in its first extended position, the top portion thereof may protrude less than 120 mm from the floor, when in use.

The second set of one or more connections may include:
a third gas connector which is fluidly connected to the first gas connector, wherein the third gas connector is configured to allow a third gas pipe/gas hose to be connected thereto such that gas may, in use, flow from the first gas pipe/gas hose to the third gas pipe/gas hose via the first gas connector and the third gas connector;
a third power connector/connection which is electrically connected to the first power connector/connection, wherein the third power connector/connection is configured to allow a third power supply cable to be connected thereto in order to allow, in use, power to be supplied from the first power supply cable to the third power supply cable via the first power connector/connection and the third power connector/connection; and/or
a third data connector/connection which is communicatively connected to the first data connector/connection or to another data connector/connection of the connector input arrangement, wherein the third data connector/connection is configured to allow a third data cable to be connected thereto in order to allow for data flow between
   the third data cable, and
   the first data connector/connection or said another data connector/connection of the connector input arrangement.

The actuator may be configured to displace the connector member between four different positions, wherein the four different positions include:
the retracted position;
the first extended position;
the second extended position; and
a third extended position in which the connector member extends further out of the recess/cavity than in the second extended position,
wherein the controller may be configured to lock/secure the connector member in each of its four different positions.

When the connector member is in its first extended position, a top portion thereof may protrude less than 150 mm, preferably less than 130 mm, more preferably less than 120 mm, even more preferably less than 118 mm, ideally about 116 mm (or less), from the floor, when in use.

The retractable connector arrangement may include one or more UVC (Ultraviolet-C) lights which is/are mounted on the connector member and which is/are configured to perform a decontamination/disinfection function in order to decontaminate/disinfect at least a portion of the room when in use, when the connector member is in its first extended position, second extended position or third extended position.

The retractable connector arrangement may include one or more sensors which is/are configured to detect when an object/obstruction is located on top of the connector member, when the connector member is in its retracted position. The controller may be configured to prevent the displacement of the connector member out of its retracted position, when an object/obstruction is sensed to be located on top of the connector member.

The retractable connector arrangement may include one or more sensors which is/are configured to detect a possible obstruction when the connector member is being lowered or about to be lowered. The controller may be configured to prevent the lowering of the connector member, when a possible obstruction is sensed.

When the connector member is in its retracted position a top portion of the retractable connector arrangement may be flush with the floor (i.e. a top surface of the floor), when in use.

In accordance with a second aspect of the invention there is provided an operating room system which includes at least one retractable connector arrangement in accordance with the first aspect of the invention, which is installed in a floor of an operating room.

The retractable connector arrangement may therefore include a connector input arrangement which is located underneath the floor and which includes
a first gas connector to which a first gas pipe/gas hose is connected for supplying gas to the retractable connector arrangement, wherein the first gas pipe/gas hose is located underneath the floor,
a first vacuum connector to which a first vacuum pipe/hose is connected for connecting the first vacuum connector to a medical vacuum system, wherein the first vacuum pipe/hose is located underneath the floor,
a first power connector/connection to which a first power supply cable is connected, wherein the first power pipe/gas hose is located underneath the floor, and/or
a first data connector/connection to which a first data cable is connected, wherein the firs data cable is located underneath the floor,
   wherein the first set of one or more connections includes:
a second gas connector which is fluidly connected to the first gas connector, wherein the second gas connector is configured to allow a second gas pipe/gas hose to be connected thereto such that gas may, in use, flow from the first gas pipe/gas hose to the second gas pipe/gas hose, so that the first second gas pipe/gas hose can be used within the operating room;
a second vacuum connector which is fluidly connected to the first vacuum connector, wherein the second vacuum connector is configured to allow a second vacuum pipe/hose to be connected thereto to facilitate flow from the second vacuum pipe/hose to the first vacuum pipe/hose via the second vacuum connector and the first vacuum connector;
a second power connector/connection which is electrically connected to the first power connector/connection, wherein the second power connector/connection is configured to allow a second power supply cable to be connected thereto in order to allow, in use, power to be supplied from the first power supply cable to the second power supply cable via the first power connector/connection and the second power connector/connection, so that the second power supply cable can be used to supply power within the operating room; and/or
a second data connector/connection which is communicatively connected to the first data connector/connection, wherein the second data connector/connection is configured to allow a second data cable to be connected thereto in order to allow for data flow between the first data cable and the second data cable via the first data connector/connection and the second data connector/connection.

The operating room system may include a controller for operating the actuator.

In accordance with a third aspect of the invention there is provided a retractable connector arrangement which is installable in a floor of a room, wherein the retractable connector arrangement includes:
a base member which defines a recess and which is, in use, mounted within the floor;
a connector member which is displaceably mounted to the base member, wherein the connector member includes a first set of one or more connectors; and
an actuator which is configured to displace the connector member between at least three different positions, wherein the at least three different positions include:
   a retracted position in which the connector member is housed in the recess,
   a first extended position in which the connector member extends partially out of the recess such that the first set of one or more connectors is located above the floor so that it is accessible for allowing one or more external connectors to be connected to the first set of one or more connectors, when in use, and
   a second extended position in which the connector member extends further out of the recess than in the first extended position.

The retractable connector arrangement may include any one or more of the features of the retractable connector arrangement in accordance with the first aspect of the invention described above.

### BRIEF DESCRIPTION OF THE DRAWINGS

The invention will now be described, by way of example, with reference to the accompanying drawings. In the drawings:

FIG. 1 shows a three-dimensional view of a retractable connector arrangement in accordance with the invention, when a connector member thereof is in a third fully extended position;

FIG. 2 shows another three-dimensional view of the retractable connector arrangement shown in FIG. 1;

FIG. 3a shows a three-dimensional view of the retractable connector arrangement in accordance with the invention, when the connector member thereof is in its third fully extended position;

FIG. 3b shows a three-dimensional view of the retractable connector arrangement in accordance with the invention, when the connector member thereof is in a second extended position;

FIG. 3c shows a three-dimensional view of the retractable connector arrangement in accordance with the invention, when the connector member thereof is in a retracted position;

FIG. 4a shows a side view of part of the retractable connector arrangement shown in FIG. 3a;

FIG. 4b shows a side view of part of the retractable connector arrangement shown in FIG. 3b;

FIG. 4c shows a side view of part of the retractable connector arrangement shown in FIG. 3a, where the connector member thereof is in a first extended position;

FIG. 4d shows a side view of part of the retractable connector arrangement shown in FIG. 3c;

FIG. 5 shows a sectional side view of the retractable connector arrangement in accordance with the invention, where the connector member thereof is in its retracted position;

FIG. 6 shows a sectional side view of the retractable connector arrangement shown in FIG. 5, where the connector member thereof is in its third fully extended position;

FIG. 7 shows a sectional side view of the retractable connector arrangement shown in FIG. 6, where a portion of the retractable connector arrangement has been enlarged which illustrates a seal;

FIG. 8A shows a top view of a retractable connector arrangement in accordance with the invention, showing dimensions in mm.

FIG. 8B shows a side view of the retractable connector arrangement shown in FIG. 8A, showing dimensions in mm;

FIG. 9A shows a side view of a retractable connector arrangement in accordance with the invention, showing dimensions in mm;

FIG. 9B shows an enlarged view of the portion marked “A” in FIG. 9A which shows an equipotential earth.

FIG. 9C shows an enlarged view of the portion marked “B” in FIG. 9A.

FIG. 9D shows an enlarged view of the portion marked “C” in FIG. 9A.

FIG. 10A shows a plan view of part of a connector input arrangement of the retractable connector arrangement in accordance with the invention, which includes a plate;

FIG. 10B shows a three-dimensional view of the plate shown in FIG. 10A;

FIG. 11 shows a sectional side view of an alternative example of a retractable connector arrangement in accordance with the invention, where a portion of the retractable connector arrangement has been enlarged which illustrates an alternative type of seal;

FIG. 12 shows a functional layout of an operating room system in accordance with the invention;

FIG. 13 shows a schematic side view of the retractable connector arrangement in accordance with the invention, when a medical cart is positioned over it and connected thereto;

FIG. 14 shows a three-dimensional view of a retractable connector arrangement in accordance with the invention;

FIG. 15 shows an enlarged three-dimensional view of a portion of the retractable connector arrangement shown in FIG. 14;

FIG. 16 shows a three-dimensional view of an alternative embodiment of the retractable connector arrangement shown in FIG. 1;

FIG. 17 shows a three-dimensional view of a connector member of the retractable connector arrangement shown in FIG. 16;

FIG. 18 shows a side view of the connector member shown in FIG. 17;

FIG. 19 shows another side view of the connector member shown in FIG. 17; and

FIG. 20 shows a sectional side view of the retractable connector arrangement shown in FIG. 16.

### DESCRIPTION OF PREFERRED EMBODIMENTS

The present invention relates to a retractable connector which is typically installed in the floor of a room, more specifically an operating room. The retractable connector essentially acts as a type of docket station for connecting gas supplies, medical vacuum systems, power supplies and data cables. The retractable connector can also be referred to as a so-called “floor pod”.

The retractable connector arrangement 10 includes a base member in the form of a housing 12 The housing 12 defines a cylindrical recess 14 which leads into the housing 12 from a top portion 16 thereof. In use, the housing 12 is fitted inside a recess provided in a floor 100 of an operating room 102 such that the top portion 16 is flush with the floor 100. The housing 12 may typically be fully fire rated.

The retractable connector arrangement 10 further includes a connector member 18 which is displaceably mounted within the recess 14 of the housing 12 such that (i) it can be housed fully within the recess 14 such that a top portion 20 of the connector member 18 is flush with the top portion 16 on the housing 12 and the floor 100, and (ii) the connector member 18 can extend upwardly, in a telescopic manner, by means of an actuator 70, such that a portion of the connector member 18 extends upwardly from the floor 100 into the operating room 102. The connector member 18 has a cylindrical housing/body 23 which is shaped and sized in a complemental manner to the recess 14 defined by the housing 12 such that it fits snugly therein.

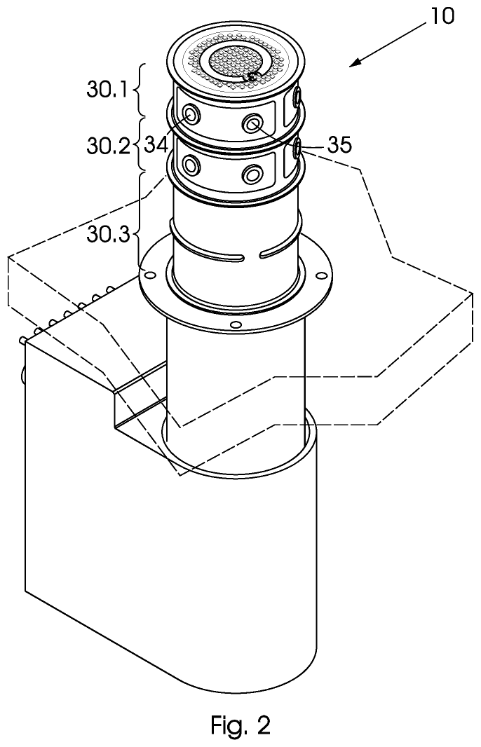

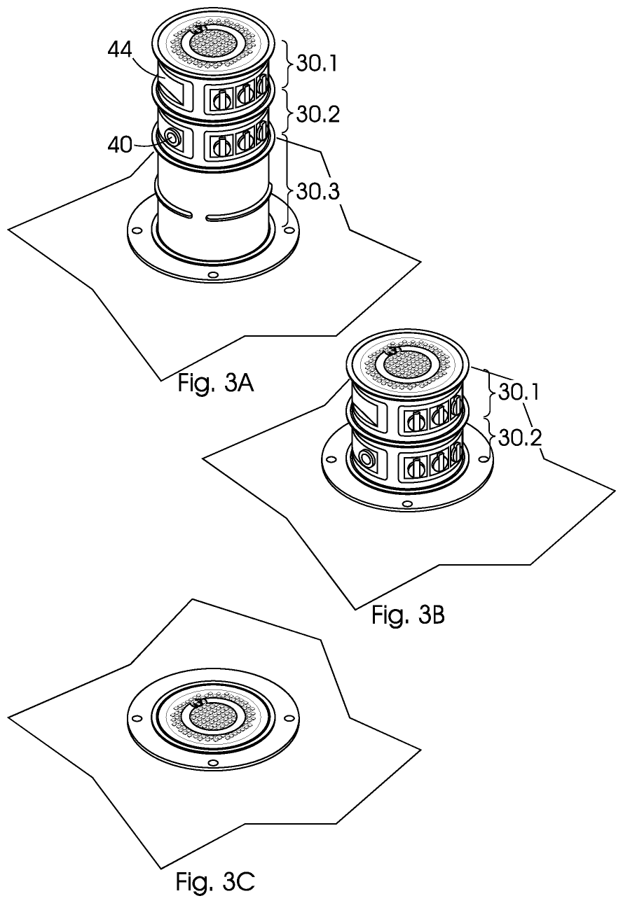

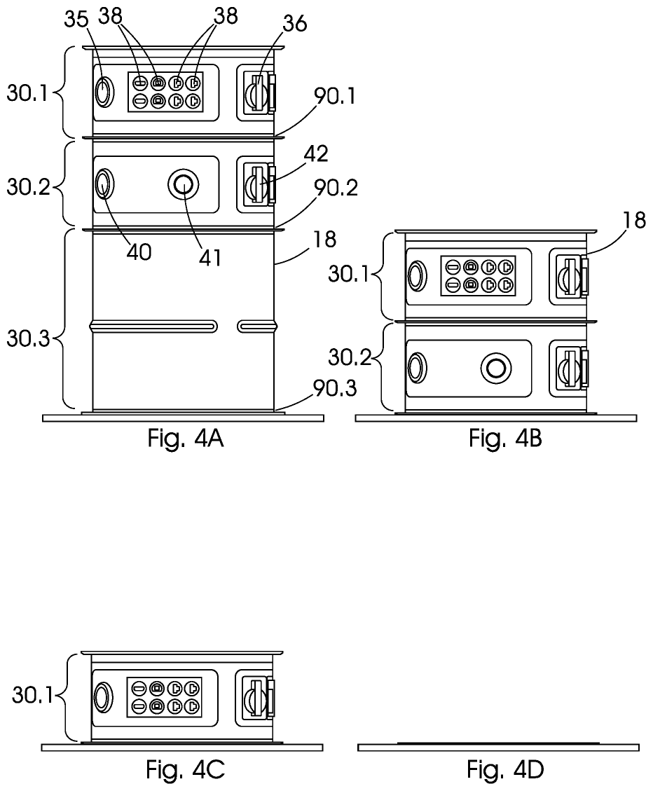

The actuator 70 is mounted inside the housing 12 and is operatively connected to the connector member 18 in order to displace the connector member 18 between a retracted position (see FIGS. 2C and 3D), a first extended position (see FIG. 4C), a second extended position (see FIGS. 3B and 4B) and a third fully extended position (see FIGS. 3A and 4A). More specifically, the actuator 70 includes a telescoping lift member/arm 71 which extends upwardly and braces against a portion 15 of the connector member 18 in order to displace the connector member 18 between the different positions. These positions are described in more detail further below. The actuator 70 and lifting arm 71 may form part of a so-called lifting column, such as the Desklift™ DL6 lifting column from Linak™ (see https://cdn.linak.com/-/media/files/data-sheet-source/en/lifting-column-dl6-data-sheet-eng.pdf).

The connector member 18 effectively includes three sections/portions 30.1-30.3 which are divided along a length of the housing 22, namely an upper section 30.1, a middle section 30.2 and a lower section 30.3.

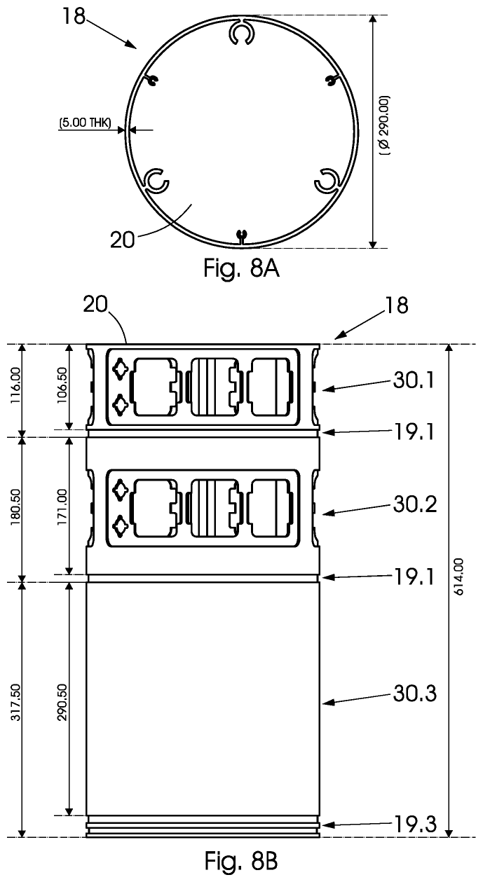

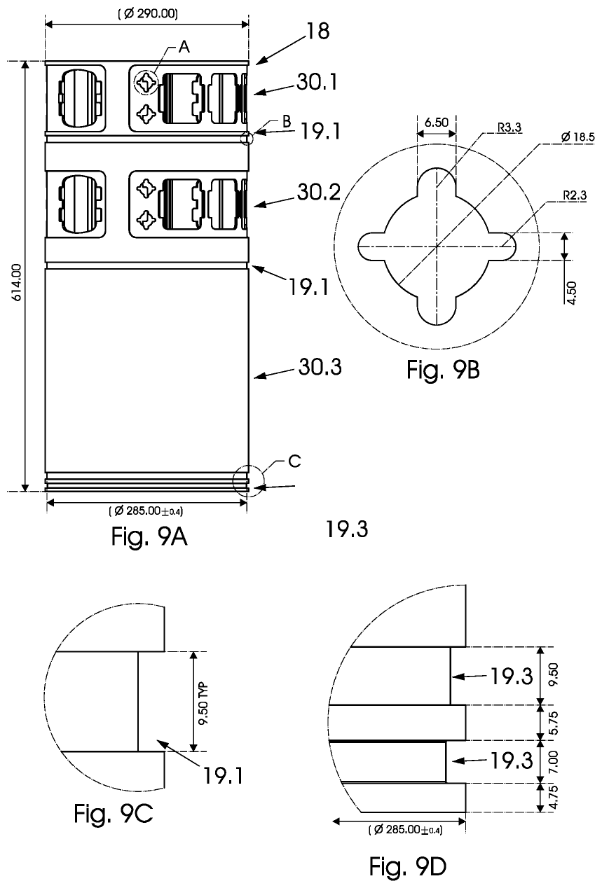

A first circumferential seal 90.1 (e.g. a wiper seal) is mounted around the connector member 18, in-between the upper section 30.1 and the middle section 30.2. The seal 90.1 braces/urges against an inner surface of the housing 12 to effectively provide a seal between the connector member 18 and the housing 12 to help prevent dirt (and other particles/fluids) from entering the housing 12 via the operating room 102 (thereby to help in infection control integrity by keeping the floor pod clean and dry). A second circumferential seal 90.2 (e.g. a wiper seal) is mounted around the connector member 18, just below the middle section 30.2. A third circumferential seal/skirt 90.3 (e.g. a D seal) is mounted around connector member 18, close to a lower end of the connector member 18. The skirt 90.3 may be flexible and may be configured to prevent liquids or materials entering the housing 12 whether the connector member 18 in a raised or retracted position. In the example embodiment shown in FIGS. 8A-9D, the connector member 18 defines a first circumferential recess 19.1 within which the first circumferential seal 90.1 can be mounted, a second circumferential recess 19.2 within which the second circumferential seal 90.2 can be mounted, and a pair of circumferential recesses 19.3 within which the third circumferential seal 90.3 can be mounted.

The upper section 30.1 includes a first set of connectors. The first set of connectors includes:
one or more gas connectors/connections 34 to which one or more medical gas hoses/pipes can be connected;
one or more vacuum connectors/connections 35 to which one or more medical vacuum hoses/pipes can be connected;
one or more power connectors/connections 36 (typically two or more power connectors/connections 36) to which one or more power supply cables can be connected; and
one or more data connectors/connections 38 (typically two or more data connectors/connections 38) to which one or more data cables can be connected.

The gas connectors/connections 34 may typically be in the form of gas pipe/hose connector fittings or gas pipe/hose connector sockets.

The vacuum connectors/connections 34 may typically be in the form of vacuum pipe/hose connector fittings or vacuum pipe/hose connector sockets.

The power connectors/connections 36 may typically be in the form of electric sockets.

The data connectors/connections 38 may typically be in the form of data connection sockets.

The middle section 30.2 also includes:
one or more gas connectors/connections 40 to which one or more medical gas hoses/pipes can be connected;
one or more vacuum connectors/connections 41 to which one or more medical vacuum hoses/pipes can be connected;
one or more power connectors/connections 42 (typically two or more power connectors/connections 42) to which one or more power supply cables can be connected;
one or more data connectors/connections 44 (typically two or more data connectors/connections 44) to which one or more data cables can be connected.

A mounting plate and cover plate for the gas connectors 40 and power connectors 42 may have the same outer size and shape, for flexibility and interchangeability in the floor pod configuration.

The retractable connector arrangement 10 includes a connector input arrangement 50 which is connected to a lower portion of the housing 12. More specifically, the connector input arrangement 50 has a housing 51 which is fitted around the lower portion of the housing 12. In use, the housing 51 is also positioned underneath the floor 100.

The connector input arrangement 50 includes a gas connector/connection 52 which corresponds to the gas connectors/connections 34, 40 provided in the upper and middle sections 30.1, 30.2 of the connector member 18. More specifically, the gas connector/connection 52 is provided on an outer side of the housing 52 in order to allow an external gas pipe/hose 104 to connect thereto. This external gas pipe/hose 104 is located below the floor 100 and supplies gas, more specifically medical gas, from a gas supply 130 (e.g. piped medical gases system), which is part of the hospital medical gases infrastructure, to the retractable connector arrangement 10. An internal gas/hose 60 interconnects the gas connector 52 to both gas connectors 34, 40. In order to supply gas to both gas connectors 34, 40. The internal gas pipe/hose 60 can split into two parts in order to supply both gas connectors 34, 40 respectively. As a result, the gas connectors 34, 40 are flowing connected to the external gas pipe/hose 104, thereby allowing medical personnel to connect an external hose/pipe to one of the gas connectors 34, 40 in order to supply gas to a patient (or a particular medical machine) in the operating room 102, if required, during a medical procedure/operation.

It should be noted that the upper and middle sections 30.1, 30.2 can each include a plurality of gas connectors/connections 34, 40 which are flowingly connected to the gas connector/connection 52.

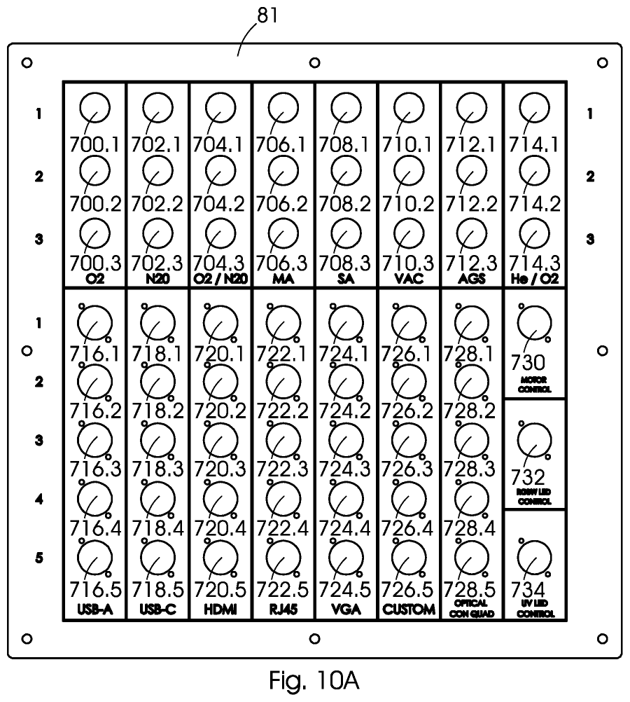

Furthermore, it should be noted that in a slight alternative embodiment, each of the gas connectors 34, 40 may have a corresponding gas connector/connection 52.1-52.3 (see FIGS. 10A&B) provided by the connector input arrangement 50. In other words, the connector input arrangement 50 may include a plurality of gas connectors/connections 52, wherein each gas connector/connection 52 is flowingly connected to a particular gas connector 34, 40 (e.g. via a gas specific NIST (Non Interchangeable Screwed Thread) connection on the pipe/hose).

The connector input arrangement 50 includes a vacuum connector/connection 53 which corresponds to the vacuum connectors/connections 35, 41 provided in the upper and middle sections 30.1, 30.2 of the connector member 18. More specifically the vacuum connector/connection 53 is provided on an outer side of the housing 52 in order to allow an external vacuum pipe/hose 105 to connect thereto. This vacuum gas pipe/hose 105 is located below the floor 100 and connects the vacuum connector/connection 53 to a medical vacuum system 132 which is located further away at another location within the hospital. An internal gas/hose 61 interconnects the vacuum connector/connection 53 to both gas connectors 35, 41. In order to provide both connections, the internal vacuum pipe/house 61 can split into two parts in order to connect to both vacuum connectors 35, 41 respectively. As a result, the vacuum connectors 35, 41 are flowing connected to the external gas pipe/hose 105, thereby allowing medical personnel to connect an external vacuum hose/pipe 502 to one of the vacuum connectors 35, 41 in order to connect it to the medical vacuum system 132.

It should be noted that the upper and middle sections can each include a plurality of vacuum connectors/connections which are flowingly connected to the vacuum connector/connection 53.

Furthermore, it should be noted that in a slight alternative embodiment, each of the vacuum connectors/connections 35, 41 may have a corresponding vacuum connector/connection 53.1-53.3 (see FIGS. 10A&B) provided by the connector input arrangement 50. In other words, the connector input arrangement 50 may include a plurality of vacuum connectors/connections 53.1-53.3, wherein each vacuum connector/connection 53.1-53.3 is flowingly connected to a particular vacuum connector/connection 35, 41 (e.g. via a pipe/hose).

The connector input arrangement 50 includes a data connector/connection 63 which corresponds to the data connectors/connections 38, 44 provided in the upper and middle sections 30.1, 30.2 of the connector member 18. More specifically the data connector/connection 63 is provided on the outer side of the housing 52 (next to the gas connector/connection 52 and the vacuum connector/connection 53) in order to allow an external data cable 110 to be connected thereto. This external data cable 110 is also located below the floor 100 and is connected to a computer/computing system/processor 136 located further away (or to the controller 144). An internal data cable 64 interconnects the data connector/connection 63 to the data connectors/connections 38, 44 provided in the top and middle sections. Medical personnel can therefore plug in an external data cable 504 at one of the data connectors/connections 38, 44, in order to send/receive information via the data cables 110, 64.

The connector input arrangement 50 includes another data connector/connection 66 which is provided on the outer side of the housing 52 (next to the gas connector/connection 52, the power supply connector/connection 54 and the data connector/connection 62) in order to allow an external data cable 112 to be connected thereto. The data connector/connection 62 is operatively connected to the actuator 70 in order to relay control instructions from a controller/control module 144 via the external data cable 112 to the actuator 70, in order to displace the connector member 18 between its various positions. In an alternative embodiment, the controller/control module 144 may send control instructions to the actuator 70 via wireless communication.

The gas hoses 60, 61, power cable(s) 62 and data cable(s) 64 are fitted within an energy chain 111 which is configured to protect the hoses 60, 61 and cables 63,64, and allow them to be displaced/moved as the connector member 18 is displaced between its various positions.

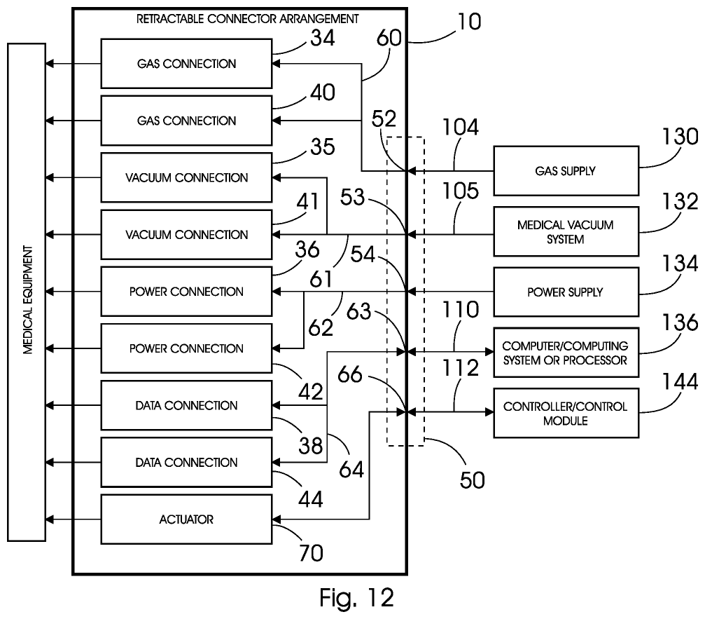

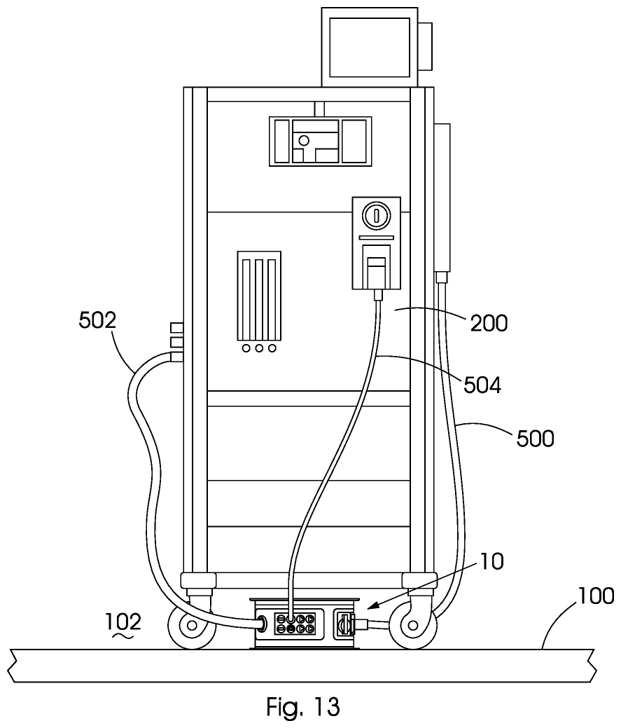

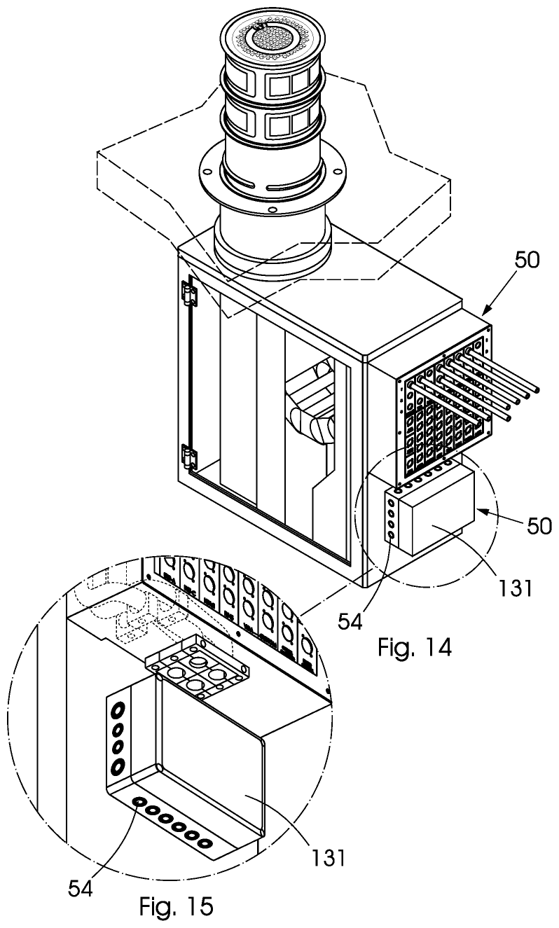

The connector input arrangement 50 includes a power supply connector/connection 54 which corresponds to the power supply connectors/connections 36, 42 provided in the upper and middle sections 30.1, 30.2 of the connector member 18. More specifically, the power supply connector/connection 54 is provided via an enclosure 131 (see FIGS. 14 and 15) provided on the outer side of the housing 52 in order to allow an external power supply cable to be connected thereto, in order to supply power to the connector input arrangement 50. This external power supply cable is also located below the floor 100 and is connected to a power supply located further away. An internal power cable 62 interconnects the power supply connector/connection 54 to the power supply connectors/connections 36, 42 provided in the top and middle sections. Power provided from the power supply 134 is therefore effectively provided to the power supply connectors/connections 36, 42 which can be used within the operating room 102 (e.g. see the external power supply cable 500 in FIG. 13).

It should be noted that the upper and middle sections can each include a plurality of power supply connectors/connections which are electrically connected to the power supply connector/connection 54.

Furthermore, it should be noted that in a slight alternative embodiment, each of the power supply connectors/connections 36, 42 may have a corresponding power supply connector/connection provided by the connector input arrangement 50 (e.g. at/within the enclosure 131). In other words, the connector input arrangement 50 may include a plurality of power supply connectors/connections, wherein each power supply connectors/connections is operatively/electrically connected to a particular power supply connector/connection 36, 42 (e.g. via a power/electric cable or cord).

In a specific example embodiment shown in FIGS. 10A&B, the connector input arrangement 50 includes a plate 81 which defines a plurality of openings via which external pipes/hoses and cables can be connected. More specifically, the connector input arrangement 50 includes the following connections/connectors:
three oxygen connections/connectors 700.1-700.3 for allowing external oxygen pipes/hoses to be connected thereto (for supplying oxygen to the connector arrangement 10 and subsequently to the operating room 102);
three dinitrogenoxide (N2O) connections/connectors 702.1-702.3 for allowing external dinitrogenoxide pipes/hoses to be connected thereto (for supplying dinitrogenoxide to the connector arrangement 10 and subsequently to the operating room 102);
three gas connections/connectors 704.1-704.3 for allowing external oxygen pipes/hoses or external dinitrogenoxide pipes/hoses to be connected thereto (for supplying oxygen and/or dinitrogenoxide to the connector arrangement 10 and subsequently to the operating room 102);
three medical air (MA) (e.g. 4 bar) connections/connectors 706.1-706.3 for allowing medical air pipes to be connected thereto (for supplying medical air to a patient);
three surgical air connections/connectors 708.1-708.3 for allowing a surgical air pipes (e.g. 7 bar) to be connected thereto in order to provide pressurized air for high pressure air driven tools/instruments used by surgeons;
three vacuum tube connections/connectors 710.1-710.3 for allowing external vacuum tubes to be connected thereto;
three AGS (Anaesthetic Gas Scavenging) connections/connectors 712.1-712.3 for allowing AGS pipes to be connected thereto (An AGS system is used to remove surplus anaesthetic gas from the operating field/area, so nobody else, other than the patient, is subjected to the effects of anaesthetic gas);
three gas connections/connectors 714.1-714.3 for allowing external oxygen pipes/hoses or external helium pipes/hoses to be connected thereto (for supplying oxygen and/or helium to the connector arrangement 10 and subsequently to the operating room 102);
five USB-A connections/connectors 716.1-716.5 for allowing external USB-A data cables to be connected thereto;
five USB-C connections/connectors 718.1-718.5 for allowing external USB-C data cables to be connected thereto;
five HDMI connections/connectors 720.1-720.5 for allowing external HDMI data cables to be connected thereto;
five RJ45 connections/connectors 722.1-722.5 for allowing external RJ45 data cables to be connected thereto;
five VGA connections/connectors 724.1-724.5 for allowing external HDMI data cables to be connected thereto;
five custom connections/connectors 726.1-726.5 for allowing custom data cables to be connected thereto;
five OpticalCON QUAD connections/connectors 728.1-728.3 for allowing OpticalCON QUAD cables to be connected thereto;
a motor control connection/connector 730 for allowing a communication/data cable to be connected thereto in order to send control instructions (e.g. from the controller 144) for controlling the operation of a motor of the actuator 70;
a RGBW (red/green/blue/white) LED (Light Emitting Diode) control connection/connector 732 for allowing a communication/data cable to be connected thereto in order to send control instructions (e.g. from the controller 144) for controlling the operation of the LED lights; and
a UV LED control connection/connector 734 for allowing a communication/data cable to be connected thereto in order to send control instructions (e.g. from the controller 144) for controlling the operation of the UV lights.

Each of the connections/connectors provided for by the connector input arrangement 50 is operatively connected to a corresponding connection/connector which is provided in either the upper section 30.1 or the middle section 30.2, or to supply motor control/RGBW light control/UV LED light control.

It should be noted that the exact number and types of connections/connectors provided by the connector input arrangement 50 can easily be adapted/changed, depending on the particular needs of an operating room. It should therefore be appreciated that the specific number and types of connections/connectors shown in FIG. 10A should not be seen as to limit the scope of the invention, but merely one example.

The retractable connector arrangement 10 typically forms part of an operating room system. The system may include the controller/control module 144.

In the retracted position (see FIGS. 2C and 3D), the connector member 18 is housed fully in the recess 14 and the top portion 22 of the connector member 18 is flush with the top portion 16 of the housing 12 and the floor 100 (see FIGS. 3c and 4d).

In the first extended position (see FIG. 4C), the connector member 18 extends partially out of the recess 14 such that the upper section 30.1 is exposed and accessible from within the operating room so that medical personnel can utilise:
the gas connector(s) 34 (e.g. to supply gas to a person undergoing an operating in the operating room);
the vacuum connector(s) 35 (for connection to the medical vacuum system 132);
the power connector(s) 36 (e.g. to supply power to one or more medical devices/apparatuses/systems which need to be utilised during an operation); and
the data connectors/connections 38 (e.g. to connect an anesthesia patient monitoring system).

When the connector member 18 is in its first extended position, a top portion thereof protrudes by about 116 mm from the floor, when in use. Since medical carts 200 used in operating rooms typically have a clearance underneath of more than 150 mm, it allows these carts 200 to be positioned over the connector member 18 while the connector member 18 is in its first extended position. In practice, the various connections provided by the upper section 30.1 can be used by these carts 200 or by medical machines/devices which are provided on these cars 200. These carts 200 may, for example, be anesthesia carts, laparoscopy carts or arthroscopy carts. Surgical microscopes or ultrasound devices may also be provided on these carts 200. Once the cart 200 has been connected to the connections provided by the upper section 30.1, it can be placed over the connector member 18. As a result, the presence of cables and hoses lying throughout the operating room (especially around the operating table working space), in order to provide connections to various medical devices, is reduced to a great extent, thereby making the operating room safer.

In the second extended position (see FIGS. 3B and 4B), the connector member 18 extends partially out of the recess 14 such that both the upper section 30.1 and the middle section 30.2 are exposed and accessible from within the operating room 102 so that medical personnel can also utilise:
the gas connector(s) 40 (e.g. to supply gas to a person undergoing an operating in the operating room);
the vacuum connector(s) 41 (for connection to the medical vacuum system);
the power connector(s) 42 (e.g. to supply power to one or more medical devices/apparatuses/systems which need to be utilised during an operation); and
the data connectors/connections 44 (e.g. to an anesthesia patient monitoring system).

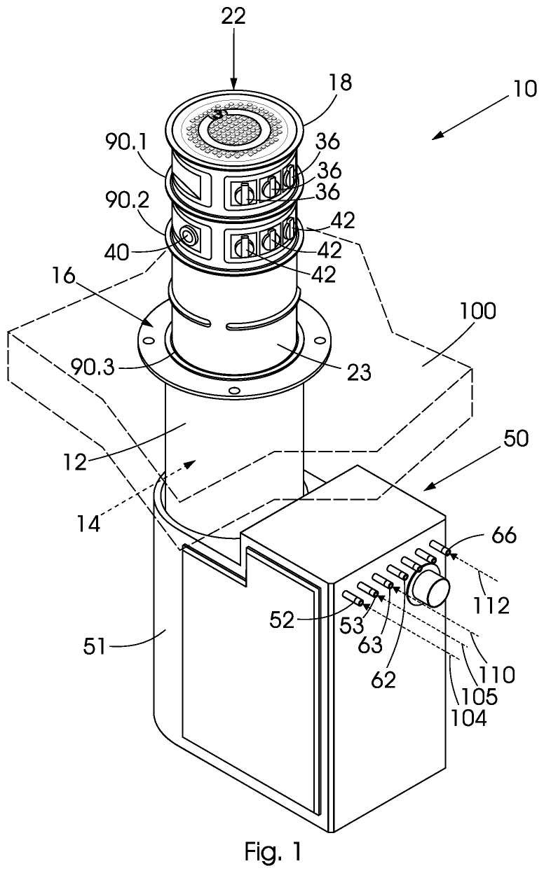

In the third fully extended position (see FIGS. 1-3A and 4A), the upper section 30.1 and the middle section 30.2 are extended higher up into the operating room, in order to make it easier for medical personnel to connect medical equipment to the connections provided in the upper section 30.1 and middle section 30.2 (i.e. the height of the upper section 30.1 and the middle section 30.2, when in the fully extended position, makes it more accessible for medical personnel to plug in whatever may be required for a particular operation). After the necessary connections have been made, the connector member 18 can be lowered to its first extended position (if only the connections provided in the first section 30.1 have been used) or the second extended position (if connections in both the first and second sections 30.1, 30.2 have been used).

When the retractable connector arrangement 10 is not used, the connector member 18 is retracted into its retracted position.

As mentioned, the operation of the retractable connector arrangement 10 (e.g. the displacement of the connector member 18 into its different positions) is controlled by a controller or control module 144.

An interactive display screen may be provided within the operating room (e.g. it may be in the form of an interactive wall touch panel), which a medical person may use in order to send control instructions to the actuator 70 in order to displace the connector member 18 into a particular position. The interactive display screen may therefore form part of the controller or control module 144. The controller or control module 144 may include a handheld controller which is operatively connected to the actuator 70 (e.g. via wireless communication or via a data connection (as described above) and which is configured to allow a medical person to send control instructions to the actuator 70. The handheld controller may be provided in the operating room 102. In one example, the handheld controller may be a smart device such as a tablet.

In practice, a plurality of these retractable connector arrangements 10 may be installed inside an operating room. For example, they may be installed all around a particular operating table working space so that different medical carts may be located around the operating table working space, while at the same time being connected to an associated retractable connector arrangement 10.

Sensor(s) may be provided in a top cover/portion 20 of the connector member 18 and may be configured to detect if something or someone is positioned on top of the connector member 18 when in its retracted position. If so, then it will not allow for the connector member 18 to be displaced into one of its extended positions (i.e. it will not operate). More specifically, the top cover/portion 20 may be a pressure sensitive top plate which is configured such that it will not operate or back off (in a similar manner to a powered window in a car) when it senses a restriction/obstacle/pressure. This safety mechanism therefore prevents the operation of the retractable connector arrangement 10, if someone stood on it when in the retracted position

The said sensor(s) (or other sensor(s)) in the top cover/portion 20 may further be configured to detect if, when the connector member 18 is in one of its extended positions and is being lowered an obstruction/possible collision such as a person's foot or hand is sensed (i.e. which is at risk of being trapped), the lowering is stopped and the connector member 18 is raised/reverted to a safe height. More specifically, the retractable connector arrangement 10 may include a collision detection system (e.g. which has a ‘Linak’™ actuator (collision detection piezoelectric sensor algorithm) to lift and lower the connector member 18. The collision detection system may include a sensor (more specifically a piezoelectric sensor) which is located within (or operatively connected to) the actuator 70 and is configured to sense a restriction or resistance in the vertical movement due to an obstruction or connected cable or hose, and the collision detection system then in response stops and backs off the motion of the actuator 70.

The top cover/portion 20 may include a light (e.g. LED light) in order to illuminate the retractable connector arrangement 10 for identification and safety in a lower light scenario

The sensors may typically be operatively connected to the controller 144 which then controls the operation of the connector member 18 as explained above (based on data received from the sensors).

The sensors used for collision/obstruction detection may form part of an off the shelf lifting column the floor pod uses to raise and lower (e.g. the Desklift™ DL6 lifting column from Linak™). Inside the lifting column itself is a piezoelectric sensor which detects a change in force and will prematurely terminate the lifting/lowering cycle and “back off” a small distance, in case of trapped fingers etc. There is also a gyroscopic sensor located in the top cover/portion, which will detect any slight change in angle whilst in operation. Such change will again prematurely terminate the cycle. In the event of the above taking place, the lifting column sends information back to the controller 144, which displays an error message.

Lights (e.g. LED lights) and an audible alarm may be provided in the connector arrangement 10 (e.g. in the connector member 18). These lights may be operated to flash and the alarm may also be activated, during the raising and lowering of the connector member 18. The lights and alarm may typically be operatively connected to the controller 144 which controls the operation thereof.

The retractable connector arrangement 10 may include UVC (Ultraviolet-C) lights. The retractable connector arrangement 10 may be configured such that, when in its fully extended position, a decontamination/disinfection mode can be selected (e.g. by an operator via the user interface) whereby the UVC lights are used to decontaminate/disinfect at least a portion of the operating room as well as the retractable connector arrangement 10 itself (i.e. it has a self-decontaminating feature). The UVC lights may be installed in the connector member 18, more specifically in a bottom third of the connector member 18 which are only exposed when the connector member 18 is in its fully extended position. The UVC lights may be mounted to, and spaced circumferentially around, the connector member 18 (i.e. similar to the first and second set of connectors). In this regard, reference sign 150 indicates a position where the UVC lights may be positioned on the connector member 18). During this process the doors of an operating room may, as a safely feature, be locked. This decontamination process will typically be undertaken at night when the room is no longer in use and locked. During decontamination/disinfection, doors of the operating room can be locked automatically by the controller 144, in order to prevent inadvertent room entry. If the door locking feature is overridden due to necessitating room entry during disinfection mode, the disinfection mode will cease by way of disabling the UVC LEDs-this is done by the controller 144.

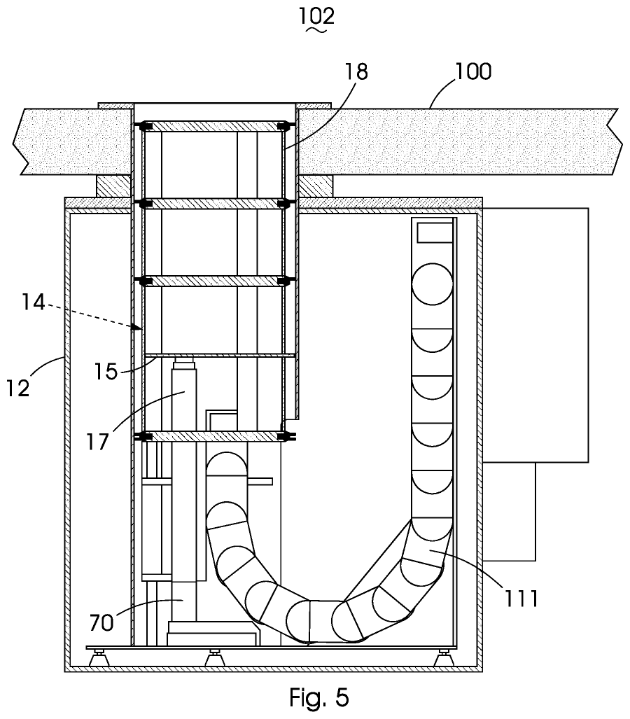

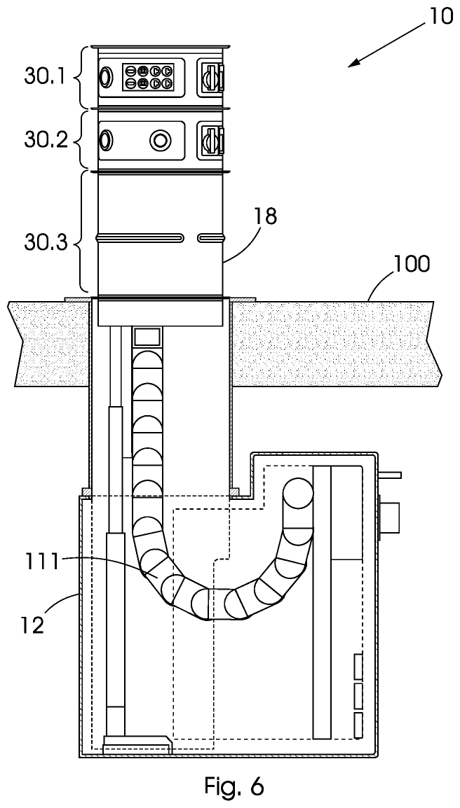

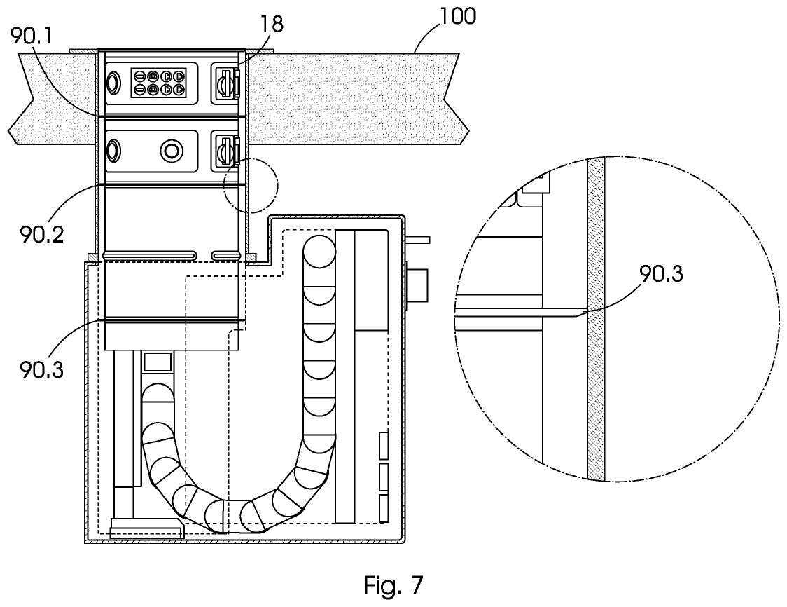

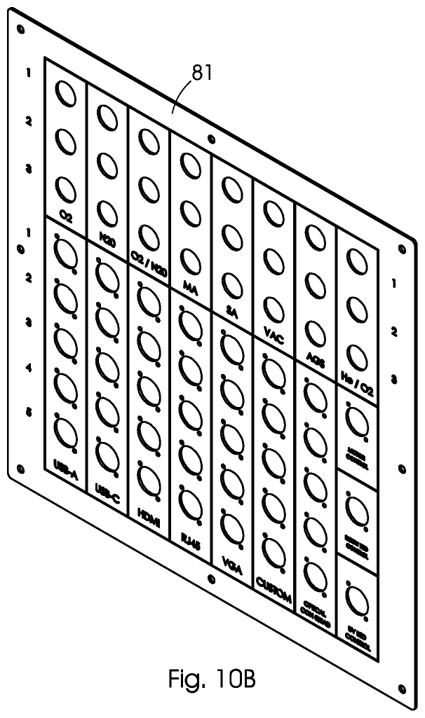

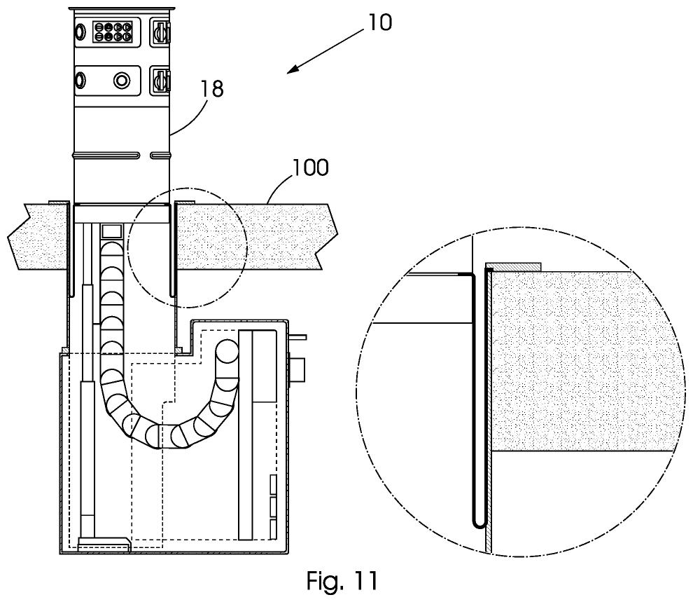

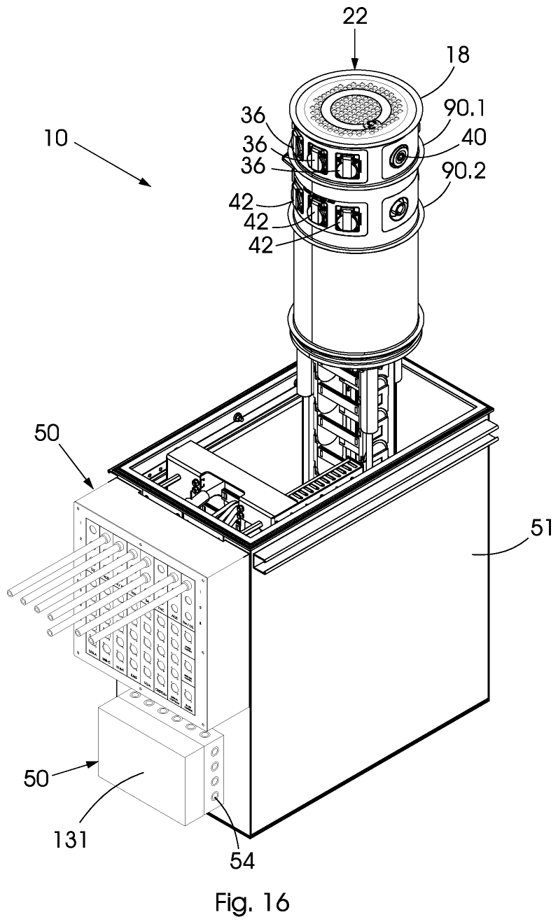

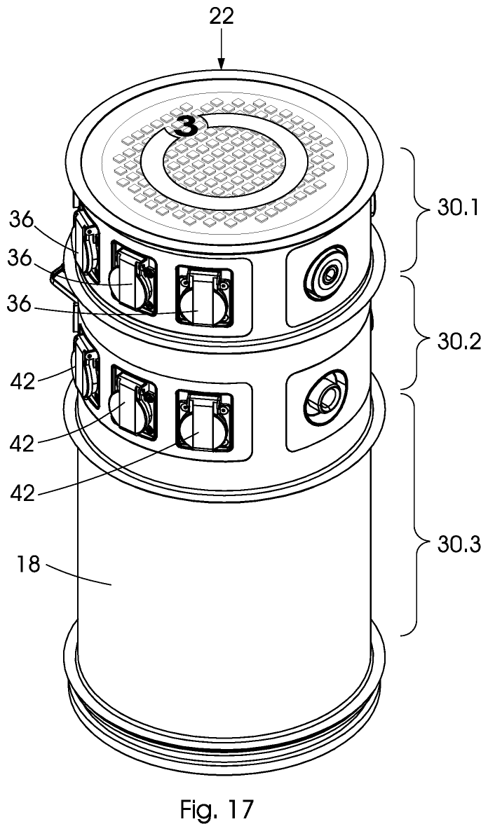

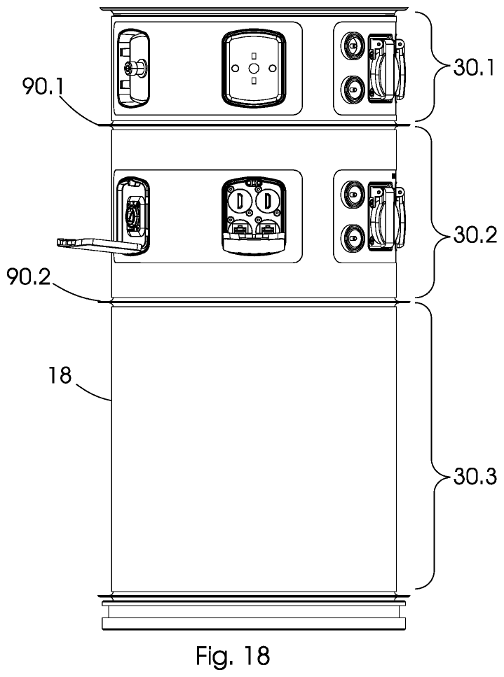

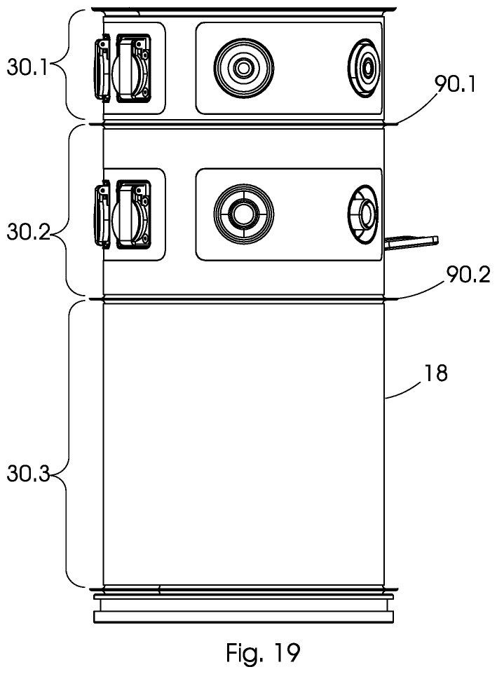

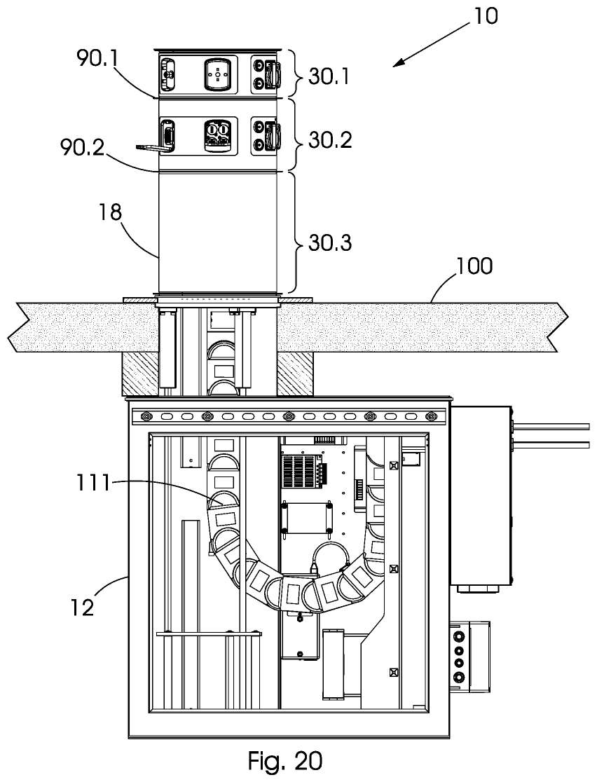

FIGS. 16-20 shows an alternative embodiment of the retractable connector arrangement shown in FIG. 1. In these drawings the same reference numerals used to indicate certain features/components in FIGS. 1-15 are also used to indicate the same features/components in FIGS. 16-20.

It should be noted that two or more retractable connector arrangements 10 can be installed in a floor of an operating room. The retractable connector arrangements 10 can then have links/channels which extend between each other, in order to allow the passage of medical equipment cables and connections under the floor, to prevent trailing leads inside the operating rooms which create trip hazards. For example, patient monitoring cables may extend from the floor pod associated with an anesthetic machine, to a floor pod associated with an operating table.

In this example, the data connectors/connections 44 have a protective cover 600 which is configured to protect data and fiber optic cables. If the cover 600 is raised/opened, cables are allowed to be plugged in and the vertical operation of the retractable connector arrangement 10 is disabled to prevent damage to the cables. When the cables are removed, the protective cover 600 can close and the vertical operation of the retractable connector arrangement 10 is again permitted. In this regard, it should be noted that a contactor is attached to the cover 600. When the cover 600 is closed, an electric circuit is closed, to allow movement. If the cover 600 is open, the electric circuit is incomplete, so the vertical movement is not allowed.

It should be noted that the first and second set of connectors provided on the first set of connectors can be adapted depending on the particular requirements. The connectors may therefore include various different connector types, such as data, air, water, CO₂, electricity, etc.

The Inventors believe that the present invention provides an innovative way of providing a retractable connection arrangement 10 which can be safely tucked away into the floor (i.e. with the top part being flush with the floor) when not needed, and then be operated to move into at least two other (preferably three) extended positions to allow for easy connection (in its fully extended position) and to maintain the connections while in a lower extended position (e.g. where the connection arrangement 10 is less intrusive and a medical cart/trolley can be positioned over it. The Inventors also believe that the connector input arrangement 50 provides for easy connection to power/data/medical gas supplies/services below floor level.

1. A retractable connector arrangement which is installable in a floor of a room, wherein the retractable connector arrangement includes:
a base member which defines a recess/cavity and which is, in use, mounted within the floor;
a connector member which is displaceably mounted to the base member, wherein the connector member includes a first set of one or more connectors and a second set of one or more connectors, wherein the second set of one or more connectors are vertically spaced from, and located operatively lower than, the first set of one or more connectors;
an actuator which is configured to displace the connector member between at least three different positions, wherein the at least three different positions include:
a retracted position in which the connector member is housed in the recess/cavity,
a first extended position in which the connector member extends partially out of the recess/cavity such that the first set of one or more connectors is located above the floor so that it is accessible for allowing one or more external connectors to be connected to the first set of one or more connectors, when in use, while the second set of one or more connectors are located below the floor and not accessible for one or more external connectors to be connected thereto, and
a second extended position in which the connector member extends further out of the recess/cavity than in the first extended position, wherein when the connector member is in its second extended position, the first set of one or more connectors and the second set of one or more connectors are located above the floor so that they are accessible for allowing one or more external connectors to be connected to the first set of one or more connectors and one or more external connectors to be connected to the second set of one or more connectors, when in use; and
a controller for operating the actuator, wherein the controller is configured to lock/secure the connector member in each of its at least three different positions.

2. The retractable connector arrangement of claim 1, which includes one or more UVC (Ultraviolet-C) lights which is/are mounted on the connector member and which is/are configured to perform a decontamination/disinfection function in order to decontaminate/disinfect at least a portion of the room, when in use.

3. The retractable connector arrangement of claim 1, which includes a first circumferential seal which is mounted around the connector member and which is located in-between the first set of one or more connectors and the second set of one or more connectors, whereby when the connector member is in its first extended position, the seal braces/urges against an inner surface of the housing in order to provide a seal.

4. The retractable connector arrangement of claim 3, wherein the first set of one or more connectors includes:
a gas connector which is configured to allow a gas pipe/gas hose to be connected thereto;
a vacuum connector which is configured to allow a medical vacuum pipe/hose to be connected thereto;
a power connector/connection which is configured to allow a power supply cable to be connected thereto; and/or
a data connector/connection which is configured to allow a data cable to be connected thereto.

5. The retractable connector arrangement of claim 4, wherein the second set of one or more connectors includes:
a gas connector which is configured to allow a gas pipe/gas hose to be connected thereto;
a vacuum connector which is configured to allow a medical vacuum pipe/hose to be connected thereto;
a power connector/connection which is configured to allow a power supply cable to be connected thereto; and/or
a data connector/connection which is configured to allow a data cable to be connected thereto.

6. The retractable connector arrangement of claim 5, which includes a connector input arrangement which includes
a first gas connector to which a first gas pipe/gas hose can be connected for supplying gas to the retractable connector arrangement, when in use,
a first vacuum connector to which a first vacuum pipe/hose can be connected in order to connect the retractable connector arrangement to a medical vacuum system, when in use;
a first power connector/connection to which a first power supply cable can be connected, when in use, and/or
a first data connector/connection for allowing a first data cable to be connected thereto, when in use,
wherein the first set of one or more connections includes:
a second gas connector which is fluidly connected to the first gas connector, wherein the second gas connector is configured to allow a second gas pipe/gas hose to be connected thereto such that gas may, in use, flow from the first gas pipe/gas hose to the second gas pipe/gas hose via the first gas connector and the second gas connector;
a second vacuum connector which is fluidly connected to the first vacuum connector, wherein the second vacuum connector is configured to allow a second vacuum pipe/hose to be connected thereto to facilitate flow from the second vacuum pipe/hose to the first vacuum pipe/hose via the second vacuum connector and the first vacuum connector, when in use;
a second power connector/connection which is electrically connected to the first power connector/connection, wherein the second power connector/connection is configured to allow a second power supply cable to be connected thereto in order to allow, in use, power to be supplied from the first power supply cable to the second power supply cable via the first power connector/connection and the second power connector/connection; and/or
a second data connector/connection which is communicatively connected to the first data connector/connection, wherein the second data connector/connection is configured to allow a second data cable to be connected thereto in order to allow for data flow between the first data cable and the second data cable via the first data connector/connection and the second data connector/connection.

7. The retractable connector arrangement of claim 1, wherein when the connector member is in its first extended position, a top portion thereof protrudes less than 150 mm from the floor, when in use.

8. The retractable connector arrangement of claim 1, wherein when the connector member is in its first extended position, a top portion thereof protrudes less than 120 mm from the floor, when in use.

9. The retractable connector arrangement of claim 6, wherein the second set of one or more connections includes:
a third gas connector which is fluidly connected to the first gas connector, wherein the third gas connector is configured to allow a third gas pipe/gas hose to be connected thereto such that gas may, in use, flow from the first gas pipe/gas hose to the third gas pipe/gas hose via the first gas connector and the third gas connector;
a third power connector/connection which is electrically connected to the first power connector/connection, wherein the third power connector/connection is configured to allow a third power supply cable to be connected thereto in order to allow, in use, power to be supplied from the first power supply cable to the third power supply cable via the first power connector/connection and the third power connector/connection; and/or
a third data connector/connection which is communicatively connected to the first data connector/connection or to another data connector/connection of the connector input arrangement, wherein the third data connector/connection is configured to allow a third data cable to be connected thereto in order to allow for data flow between
the third data cable, and
the first data connector/connection or said another data connector/connection of the connector input arrangement.

10. The retractable connector arrangement of claim 1, wherein the actuator is configured to displace the connector member between four different positions, wherein the four different positions include:
the retracted position;
the first extended position;
the second extended position; and
a third extended position in which the connector member extends further out of the recess/cavity than in the second extended position,
wherein the controller is configured to lock/secure the connector member in each of its four different positions.

11. The retractable connector arrangement of claim 10, wherein when the connector member is in its third extended position, a top portion thereof protrudes more than 500 mm from the floor, when in use.

12. The retractable connector arrangement of claim 10, which includes one or more UVC (Ultraviolet-C) lights which is/are mounted on the connector member and which is/are configured to perform a decontamination/disinfection function in order to decontaminate/disinfect at least a portion of the room when in use, when the connector member is in its first extended position, second extended position or third extended position.

13. The retractable connector arrangement of claim 1 which includes one or more sensors which is/are configured to detect when an object/obstruction is located on top of the connector member, when the connector member is in its retracted position.

14. The retractable connector arrangement of claim 13, wherein the controller is configured to prevent the displacement of the connector member out of its retracted position, when an object/obstruction is sensed to be located on top of the connector member.

15. The retractable connector arrangement of claim 1 which includes one or more sensors which is/are configured to detect a possible obstruction when the connector member is being lowered or about to be lowered.

16. The retractable connector arrangement of claim 15, wherein the controller is configured to prevent the lowering of the connector member, when a possible obstruction is sensed.

17. The retractable connector arrangement of claim 1, wherein when the connector member is in its retracted position a top portion of the retractable connector arrangement is flush with the floor, when in use.

18. An operating room system which includes at least one retractable connector arrangement as claimed in claim 1, which is installed in a floor of an operating room.

19. The operating room system of claim 18, wherein the retractable connector arrangement includes a connector input arrangement which is located underneath the floor and which includes
a first gas connector to which a first gas pipe/gas hose is connected for supplying gas to the retractable connector arrangement, wherein the first gas pipe/gas hose is located underneath the floor,
a first vacuum connector to which a first vacuum pipe/hose is connected for connecting the first vacuum connector to a medical vacuum system, wherein the first vacuum pipe/hose is located underneath the floor,
a first power connector/connection to which a first power supply cable is connected, wherein the first power pipe/gas hose is located underneath the floor, and/or
a first data connector/connection to which a first data cable is connected, wherein the firs data cable is located underneath the floor,
wherein the first set of one or more connections includes:
a second gas connector which is fluidly connected to the first gas connector, wherein the second gas connector is configured to allow a second gas pipe/gas hose to be connected thereto such that gas may, in use, flow from the first gas pipe/gas hose to the second gas pipe/gas hose, so that the first second gas pipe/gas hose can be used within the operating room;
a second vacuum connector which is fluidly connected to the first vacuum connector, wherein the second vacuum connector is configured to allow a second vacuum pipe/hose to be connected thereto to facilitate flow from the second vacuum pipe/hose to the first vacuum pipe/hose via the second vacuum connector and the first vacuum connector;
a second power connector/connection which is electrically connected to the first power connector/connection, wherein the second power connector/connection is configured to allow a second power supply cable to be connected thereto in order to allow, in use, power to be supplied from the first power supply cable to the second power supply cable via the first power connector/connection and the second power connector/connection, so that the second power supply cable can be used to supply power within the operating room; and/or
a second data connector/connection which is communicatively connected to the first data connector/connection, wherein the second data connector/connection is configured to allow a second data cable to be connected thereto in order to allow for data flow between the first data cable and the second data cable via the first data connector/connection and the second data connector/connection.
